(19) United States
(12) Patent Application Publication
(10) Pub. No.: US 2004/0197239 A1
(43) Pub. Date: Oct. 7, 2004

(54) Temperature control in combustion process

(76) Inventors: Vesna R. Mirkovic, Pearland, TX (US); W. Spencer Wheat, Missouri City, TX (US); Kevin H. Nguyen, Missouri City, TX (US); Hongqiao Sun, Bellaire, TX (US); Bhaskar Balasubramanian, Houston, TX (US)

Correspondence Address: Frank C. Turner, Chevron Services Company, Suite 4040, 1111 Bagby, Houston, TX, 77010-3031, US

(21) Appl. No.: 10/407,260

(22) Filed: Apr. 4, 2003

(51) Int. Cl. G05D 23/00; H01M 8/06

(52) U.S. Cl. 422/105; 422/109; 431/75; 700/286; 429/20

(57) ABSTRACT

Herein we disclose an apparatus, comprising: an air feed; a fuel feed; a combustion zone, capable of mixing and combusting air and fuel therein; a temperature sensor positioned within the combustion zone, capable of measuring the temperature of at least one point within the combustion zone; and a control system, comprising: a processor to which the temperature sensor is capable of reporting the measured temperature; and an air flow adjustment apparatus controlled by the processor and capable of adjusting the flow rate of air to the combustion zone in response to the reported temperature. We also disclose a reformer, a power plant, and a fuel cell comprising or associated with the apparatus. In addition, we disclose a method of maintaining the temperature of at least one point within a combustion zone within a desired temperature range, comprising: specifying the upper bound of the desired temperature range; feeding air and a fuel to the combustion zone, wherein the air is fed at an air feed rate, the fuel is fed at a fuel feed rate, the amount of air and the amount of fuel present in the combustion zone define an oxygen to fuel ratio (“O/C ratio”), provided the O/C ratio is greater than the stoichiometric O/C ratio; measuring the temperature of the at least one point within the combustion zone; and increasing the air feed rate, if the temperature of the at least one point within the combustion zone is greater than about the upper bound of the desired temperature range, provided the O/C ratio remains greater than the stoichiometric O/C ratio.

### BACKGROUND OF THE INVENTION

1. Field of the Invention

The present invention is directed to a fuel processor, and, more particularly, to the control of the temperature of an oxidizer in a fuel processor.

2. Description of the Related Art

Fuel cell technology is an alternative energy source for more conventional energy sources employing the combustion of fossil fuels. A fuel cell typically produces electricity, water, and heat from a fuel and oxygen. More particularly, fuel cells provide electricity from chemical oxidation-reduction reactions and possess significant advantages over other forms of power generation in terms of cleanliness and efficiency. Typically, fuel cells employ hydrogen as the fuel and oxygen as the oxidizing agent. The power generation is proportional to the consumption rate of the reactants.

A significant disadvantage which inhibits the wider use of fuel cells is the lack of a widespread hydrogen infrastructure. Hydrogen has a relatively low volumetric energy density and is more difficult to store and transport than the hydrocarbon fuels currently used in most power generation systems. One way to overcome this difficulty is the use of “fuel processors” or “reformers” to convert the hydrocarbons to a hydrogen rich gas stream which can be used as a feed for fuel cells. Hydrocarbon-based fuels, such as natural gas, LPG, gasoline, and diesel, require conversion for use as fuel for most fuel cells. Current art uses multi-step processes combining an initial conversion process with several clean-up processes. The initial process is most often steam reforming (“SR”), autothermal reforming (“ATR”), catalytic partial oxidation (“CPOX”), or non-catalytic partial oxidation (“POX”). The clean-up processes are usually comprised of a combination of desulfurization, high temperature water-gas shift, low temperature water-gas shift, selective CO oxidation, or selective CO methanation. Alternative processes include hydrogen selective membrane reactors and filters.

Thus, many types of fuels can be used, some of them hybrids with fossil fuels, but the ideal fuel is hydrogen. If the fuel is, for instance, hydrogen, then the combustion is very clean and, as a practical matter, only the water is left after the dissipation and/or consumption of the heat and the consumption of the electricity. Most readily available fuels (e.g., natural gas, propane and gasoline) and even the less common ones (e.g., methanol and ethanol) include hydrogen in their molecular structure. Some fuel cell implementations therefore employ a “fuel processor” that processes a particular fuel to produce a relatively pure hydrogen stream used to fuel the fuel cell.

Although fuel cells have been around for over a hundred years, the technology is still considered immature. The reasons for this state are many and difficult. Recent political, commercial, and environmental conditions have, however, spurred an increased interest in fuel cell technology. The increased interest has, in turn, generated a heightened pace of technological development.

### SUMMARY OF THE INVENTION

In one embodiment, the present invention relates to an apparatus, comprising:

an air feed;

a fuel feed;

a combustion zone, capable of mixing and combusting air and fuel therein;

a temperature sensor positioned within the combustion zone, capable of measuring the temperature of at least one point within the combustion zone; and

a control system, comprising:

a processor to which the temperature sensor is capable of reporting the measured temperature; and

an air flow adjustment apparatus controlled by the processor and capable of adjusting the flow rate of air to the combustion zone in response to the reported temperature.

In another embodiment, the present invention relates to a method of maintaining the temperature of at least one point within a combustion zone within a desired temperature range, comprising:

specifying the upper bound of the desired temperature range;

feeding air and a fuel to the combustion zone, wherein the air is fed at an air feed rate, the fuel is fed at a fuel feed rate, the amount of air and the amount of fuel present in the combustion zone define an oxygen to fuel ratio (“O/C ratio”), provided the O/C ratio is greater than the stoichiometric O/C ratio;

measuring the temperature of the at least one point within the combustion zone; and

increasing the air feed rate, if the temperature of the at least one point within the combustion zone is greater than about the upper bound of the desired temperature range, provided the O/C ratio remains greater than the stoichiometric O/C ratio.

In another embodiment, the present invention relates to a method of maintaining the temperature of at least one point within a combustion zone within a desired temperature range, comprising:

specifying the lower bound of the desired temperature range;

feeding air and a fuel to the combustion zone, wherein the air is fed at an air feed rate, the fuel is fed at a fuel feed rate, the amount of air and the amount of fuel present in the combustion zone define an O/C ratio, provided the O/C ratio is greater than the stoichiometric O/C ratio;

measuring the temperature of the at least one point within the combustion zone; and

decreasing the air feed rate, if the temperature of the at least one point within the combustion zone is less than about the lower bound of the desired temperature range, provided the O/C ratio remains greater than the stoichiometric O/C ratio.

In yet another embodiment, the present invention relates to a method for use in reforming a fuel, comprising:

feeding air to a combustion zone;

feeding a fuel to a combustion zone;

measuring the temperature of at least one point within the combustion zone; and

adjusting the flow rate of the air to the combustion zone in response to the reported temperature.

In a further embodiment, the present invention relates to a fuel processor, comprising:

an air feed;

a fuel feed;

an oxidizer, comprising:

a combustion zone, capable of mixing and combusting air and fuel therein;

a temperature sensor positioned within the combustion zone, capable of measuring the temperature of at least one point within the combustion zone; and

a control system, including:

a processor to which the temperature sensor is capable of reporting the measured temperature; and

an air flow adjustment apparatus controlled by the processor and capable of adjusting the flow rate of air to the combustion zone in response to the reported temperature.

In an additional embodiment, the present invention relates to a power plant, comprising:

a fuel cell;

a fuel processor, including:

an air feed;

a fuel feed;

an oxidizer, containing:

a combustion zone, capable of mixing and combusting air and fuel therein;

a temperature sensor positioned within the combustion zone, capable of measuring the temperature of at least one point within the combustion zone; and

a control system, comprising:

a processor to which the temperature sensor is capable of reporting the measured temperature; and

an air flow adjustment apparatus controlled by the processor and capable of adjusting the flow rate of air to the combustion zone in response to the reported temperature.

In yet an additional embodiment, the present invention relates to a control system for an oxidizer in a fuel processor, comprising:

a processor capable of receiving a temperature of at least one point in a combustion zone of the oxidizer; and

an air flow adjustment apparatus controlled by the processor and capable of adjusting the flow rate of air to the combustion zone in response to the reported temperature.

In still a further embodiment, the present invention relates to a program storage medium encoded with instructions that, when executed by a computer, perform a method comprising:

receiving a report of a temperature of at least one point in a combustion zone of an oxidizer; and

issuing a command to adjust an air flow rate to the combustion zone in response to the reported temperature.

### BRIEF DESCRIPTION OF THE DRAWINGS

The invention may be understood by reference to the following description taken in conjunction with the accompanying drawings, in which like reference numerals identify like elements, and in which:

FIG. 1 illustrates one particular embodiment of an apparatus in accordance with the present invention;

FIG. 2A and FIG. 2B conceptually illustrate a combustion zone as may be used in the implementation of the embodiment of FIG. 1;

FIG. 3 illustrates a control system as may be used in the implementation of the embodiment of FIG. 1;

FIG. 4 illustrates a heat transfer apparatus and a zone to be heated as may be used in the implementation of the embodiment of FIG. 1;

FIG. 5 represents one particular embodiment of a method in accordance with the present invention;

FIG. 6 represents another particular embodiment of a method in accordance with the present invention; and

FIG. 7 represents a further particular embodiment of a method in accordance with the present invention.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present invention is generally directed to methods and apparatus for controlling the temperature of an apparatus for combusting hydrocarbon fuel or a hydrogen-rich gas to provide process heat. The apparatus can be a component of an “oxidizer,” hereby defined as an apparatus for mixing a fuel with air. An oxidizer can oxidize tailgas, that is, the effluent of another apparatus or process. In one embodiment, the oxidizer is used in combination with a fuel processor reactor, in which the combination of apparatus can be referred to as a reformer or fuel processor, which is an apparatus for converting hydrocarbon fuel into a hydrogen-rich gas. In one embodiment, the oxidizer operates on tailgas from the anode of a fuel cell, and in this embodiment the oxidizer can be referred to as an “anode tailgas oxidizer.” In the embodiment illustrated herein, the method and apparatus provide process heat for producing a hydrogen rich gas stream from a hydrocarbon fuel for use in fuel cells. However, the apparatus can be used with other oxidizers in alternative embodiments. Furthermore, other possible uses are contemplated for the apparatus and method described herein, including any use wherein the provision of process heat at or within a specific temperature or range of temperatures is desired. Accordingly, while the invention is described herein as being used in conjunction with a fuel cell, the scope of the invention is not limited to such use.

In one embodiment, the present invention relates to an apparatus, comprising:

an air feed;

a fuel feed;

a combustion zone, capable of mixing and combusting air and fuel therein;

a temperature sensor positioned within the combustion zone, capable of measuring the temperature of at least one point within the combustion zone; and

a control system, comprising:

a processor to which the temperature sensor is capable of reporting the measured temperature; and

an air flow adjustment apparatus controlled by the processor and capable of adjusting the flow rate of air to the combustion zone in response to the reported temperature.

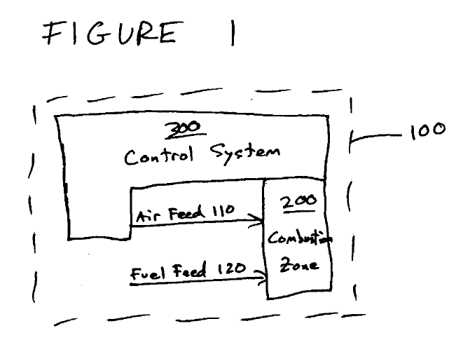

One embodiment of the apparatus 100 is shown in FIG. 1. The air feed 110 and the fuel feed 120 provide air and fuel, respectively, to the combustion zone 200. The air feed comprises an air inlet (not shown) and one or more lines (not indicated) allowing gas communication between the air inlet and the combustion zone 200. (An air flow adjustment apparatus (not shown in FIG. 1), for adjusting the flow of air through the air feed, is discussed as part of the control system 300, below). The air inlet can be open or openable to the atmosphere, to a supply of a gas mixture comprising sufficient oxygen to enable combustion of the fuel in the combustion zone 200, or both. The term “air,” as used herein, unless expressly referring to the gas mixture of the terrestrial atmosphere, encompasses any gas mixture comprising sufficient oxygen to enable combustion of the fuel. The air feed 110 can also provide air to other zones of an apparatus comprising the apparatus 100 of the present invention; such zones can include a fuel processor reactor, the cathode of a fuel cell, or both, among others. Whether the air feed 110 provides air to other zones is not material to the practice of the invention.

The fuel feed 120 comprises one or more lines (not indicated) allowing gas or liquid communication between a fuel source (not shown) and the combustion zone 200. The “fuel source,” as used herein, can comprise one or more supplies of one or more fuels, such as a tank of a hydrocarbon fuel, a tank of hydrogen, a reformate return line from a reformer, and an anode return line from the anode of a fuel cell, among others. The term “fuel,” as used herein, refers to a mixture comprising either a hydrocarbon, hydrogen, or both. The fuel feed 120 can also provide fuel to other zones of an apparatus comprising the apparatus 100 of the present invention; such zones can include a fuel processor reactor, among others. Whether the fuel feed 120 provides fuel to other zones is not material to the practice of the invention.

In both the air feed 110 and the fuel feed 120, the lines can be constructed from stainless steel, other metals, rubber, or other organic polymers. Generally, fuel can be provided through a stainless steel line. Both the air feed 110 and the fuel feed 120 can comprise one or more valves (not shown), one or more temperature sensors (not shown), one or more pressure gauges (not shown), one or more filters (not shown), one or more flow meters (not shown), or two or more of the foregoing, alternatively or in addition to other devices known in the art to be useful in air feeds or fuel feeds. The valves and other devices (not shown) capable of adjustment can be selected so as to be adjustable manually, electrically, electronically, hydraulically, or by other techniques.

In the combustion zone 200, air provided by the air feed 110 is used to combust fuel provided by the fuel feed 120. “Combustion” refers to the reaction of the fuel with oxygen to yield water vapor and, depending on the fuel, carbon dioxide. Specifically, when the fuel contains a hydrocarbon, a chemical reaction such as the following can occur (in this exemplary reaction, the hydrocarbon is methane, CH₄):

CH₄+2O₂→CO₂+2H₂O+Δ,

wherein Δ (delta) is used in a nonqualitative manner to show the reaction is exothermic (generates heat). Generally, however, some amount of heat is required to initiate or maintain the reaction.

When the fuel contains hydrogen, a chemical reaction such as the following can occur:

2H₂+O₂→2H₂O+Δ.

Again, generally, despite the overall evolution of heat by the reaction, some amount of heat is required to initiate or maintain the reaction. When the fuel contains both a hydrocarbon and hydrogen, chemical reactions such as both of the above can occur. In addition, other chemical reactions can occur. One such reaction is incomplete combustion of a hydrocarbon, by which is meant that carbon monoxide (CO) is generated alternatively or in addition to CO₂.

The combustion zone 200 can comprise one or more vessels (not shown). The vessels can be fabricated from any appropriate material capable of withstanding the temperatures, pressures, and other features of the combustions to be performed therein. In one embodiment, the combustion zone 200 vessels can be fabricated from stainless steel. The vessels of the combustion zone 200 can contain any medium wherein combustion can occur, the heat evolved by the combustion can be transferred to a desired location, the effluent evolved by the combustion can be exhausted, or two or more of the foregoing.

Devices such as one or more valves (not shown), one or more pressure gauges (not shown), or both of the foregoing, alternatively or in addition to other devices (not shown) can be disposed exterior to but in proximity to the combustion zone 200.

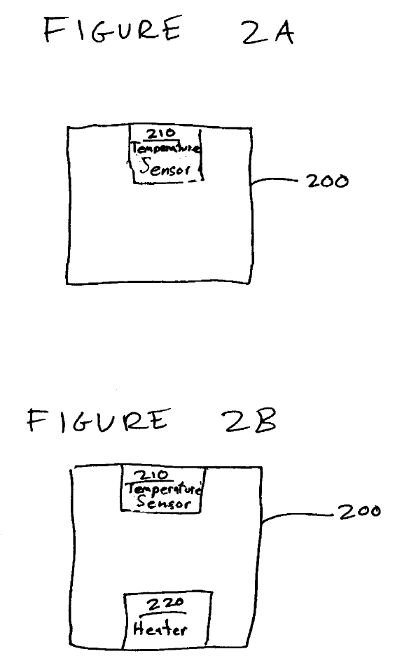

The combustion zone 200 can comprise one or more temperature sensors, as is shown in more detail in FIGS. 2A and 2B. In the embodiment shown in FIG. 2A, the combustion zone 200 comprises a temperature sensor 210. The temperature sensor 210 can measure the temperature of at least one point within the combustion zone 200. This encompasses embodiments wherein the temperature sensor 210 can measure the temperature at one, two, three, four, or more points within the combustion zone 200. In one embodiment, the temperature sensor 210 can measure the temperature at four points within the combustion zone 200. The point or points at which the temperature is measured can be selected from any points within the combustion zone 200. The skilled artisan having the benefit of this disclosure can select the point or points as a matter of routine experimentation.

Any device capable of measuring a temperature that can function at the temperatures, pressures, and other parameters at which the combustion zone 200 can be run can be used in the temperature sensor 210. In one embodiment, the temperature sensor 210 is a thermocouple.

In the embodiment shown in FIG. 2B, the combustion zone 200 comprises both the temperature sensor 210 and a heater 220. The heater 220 can provide heat to at least an area (not indicated) within the combustion zone 200 in order to initiate or maintain a combustion reaction. In one embodiment, the area is an area where air provided by the air feed 110 and fuel provided by the fuel feed 120 are combined for the purpose of combustion. The heater 220 can provide heat by electrical heating or by an exothermic chemical reaction, and can provide the heat by any of conduction, convection, or radiation.

FIGS. 1, 2A, and 2B represent the air feed 110 and the fuel feed 120 as separately entering the combustion zone 200. This is shown for convenience and is not material to the practice of the invention. In one embodiment, the air feed 110 and the fuel feed 120 are mixed in a mixing vessel (not shown) of the combustion zone 200 and fed as a mixture to the primary combustion vessel of the combustion zone 200.

Returning to FIG. 1, the apparatus can comprise a control system 300. The control system 300 can be largely software implemented on a computing apparatus, such as a rack-mounted computing apparatus, a desktop personal computer, a workstation, a notebook or laptop computer, or an embedded processor, among others. Within the teachings of the present disclosure, the precise implementation of the control system 300 is not material to the practice of the invention.

A typical computing apparatus (not shown), as will be apparent to the skilled artisan having the benefit of this disclosure, includes a processor communicating with storage over a bus system. The storage may include a hard disk, random access memory (“RAM”), a removable storage medium such as a floppy magnetic disk or an optical disk, or two or more of the foregoing, among others. The storage can be encoded with a data structure storing one or more of data set(s) acquired during operation, an operating system, user interface software, or an application, among others. The user interface software, in conjunction with a display, can implement a user interface. The user interface may include peripheral I/O devices such as a key pad or keyboard, a mouse, a joystick, or two or more of the foregoing, among others. The processor can run under the control of the operating system, which may be practically any operating system known to the art. The application can be invoked by the operating system upon power up, reset, or both, depending on the implementation of the operating system.

Thus, at least some aspects of the present invention will typically be implemented as software on an appropriately programmed computing device. The instructions may be encoded on, for example, storage, a floppy disk, an optical disk, or two or more of the foregoing, among others. The present invention therefore can include, in one aspect, a computing apparatus programmed to perform the method of the invention. In another aspect, the invention can include a program storage device encoded with instructions that, when executed by a computing apparatus, perform the method of the invention.

Some portions of the detailed descriptions herein are consequently presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantifies. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

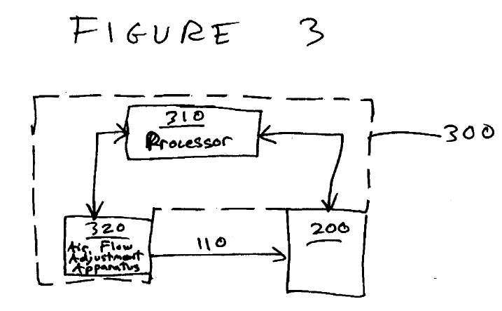

Turning to FIG. 3, in one embodiment the control system 300 comprises a processor 310 and an air flow adjustment apparatus 320, wherein the temperature sensor reports the temperature of the at least one point within the combustion zone 200 to the processor 310. This report is in the form of an electrical, optical, or other type of signal indicative of the measured temperature. The control system 300 also comprises a communications apparatus (not enumerated) for unidirectional or bidirectional transmission of data and commands between the processor 310 and the temperature sensor 210 or between the processor 310 and the air flow adjustment apparatus 320. The communications apparatus can be any device(s) capable of such unidirectional or bidirectional transmission of data and commands, including, but not limited to, a wire, a wireless link, or an optical fiber, among others apparent to the skilled artisan having the benefit of the present disclosure.

The processor 310 can be as described above.

The air flow adjustment apparatus 320 can be any apparatus capable of regulating the air flow into or through the air feed 110 or into the combustion zone 200. By “regulating” is meant reversibly increasing, reversibly decreasing, or both, as desired, the air flow, as measured in volume/minute, mass/minute, or other measures per unit time of air delivered to the combustion zone 200. In one embodiment, the air flow adjustment apparatus 320 is a blower.

In the control system 300, the processor 310 can receive the temperature of the at least one point in the combustion zone 200 as reported by the temperature sensor 210 and can adjust the air flow through the air feed 110 or into the combustion zone 200 by issuing commands to the air flow adjustment apparatus 320.

In addition to the above devices that the control system 300 can comprise, the control system 300 can comprise additional devices. Examples of such additional devices can include, but are not limited to, a fuel flow adjustment apparatus or an emergency shutdown apparatus, among others. The control system 300 of the apparatus 100 can be a component of an overall control system controlling a system of which the apparatus 100 is a part. For example, when the apparatus 100 is used to provide heat to an oxidizer in a fuel processor, the control system 300 can be a component of an overall control system controlling an air feed, a fuel feed, and a steam feed to a reformer; a reformate feed to an anode; an excess reformate recycle feed to the fuel feed 120 of the apparatus 100; an anode return feed to the fuel feed 120 of the apparatus 100; and a cathode return feed to one or more of the feeds of the reformer, among other components apparent to one of ordinary skill in the art. When the apparatus 100 is used in a different application, the control system 300 can be a component of an overall control system controlling different aspects of the overall system of such different application.

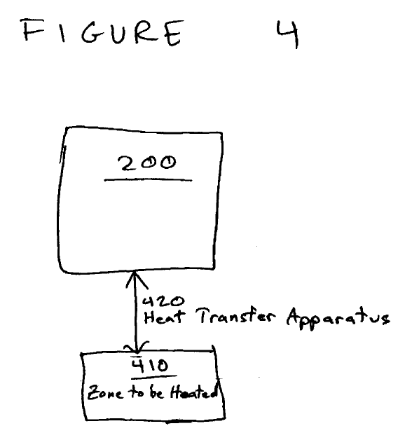

In one embodiment of the present invention, the apparatus 100 can further comprise a zone to be heated and a heat transfer apparatus. One such embodiment is represented by FIG. 4. In this embodiment, the heat transfer apparatus 420 provides heat flow communication between the combustion zone 200 and the zone to be heated 410. By “heat flow communication” is meant that heat can flow between the combustion zone 200 and the zone to be heated 410 via one or more of conduction, convection, or radiation. Typically, the heat transfer apparatus 420 comprises a material with a relatively high thermal conductivity. Although represented in FIG. 4 as being separate from the combustion zone 200, the heat transfer apparatus 420 can be a substructure disposed within the combustion zone 200.

The zone to be heated 410 can be any zone to which it is desirable to transfer heat generated by reactions within the combustion zone 200. (This assumes the zone to be heated 410 is, prior to heat transfer, at a lower temperature than the combustion zone 200). The zone to be heated 410 can comprise one or more vessels (not shown), with attendant lines (not shown), pumps (not shown), gauges (not shown), or other devices (also not shown). Generally, the zone to be heated 410 can be a zone wherein compounds in the solid, liquid, vapor, or two or more of the foregoing phases can be brought to a temperature roughly equal to that in the combustion zone 200 in order to promote a chemical reaction, a phase transition (e.g., boiling or melting), or other physical change(s), chemical change(s), or both. However, the zone to be heated 410 need not be a zone wherein compounds are subjected to a physical or chemical change. The temperature to which the zone to be heated 410 or compounds present therein can be adjusted will be a matter of routine experimentation to the skilled artisan having the benefit of the present disclosure.

In one embodiment, the zone to be heated 410 is a fuel processor. In one embodiment, the zone to be heated 410 comprises an oxidizer, i.e., a line or lines and related devices which mix fuel and air to provide a mixture of fuel and air to a fuel processor reactor.

In one embodiment, the heat transfer apparatus 420 is a coiled line, such as a coiled stainless steel line, in fluid communication with one or more lines of an oxidizer, and the zone to be heated 410 is the oxidizer. The oxidizer can be maintained at the temperature it acquires upon transfer of heat to it by insulation, supplemental heating, or other appropriate techniques, and compounds present therein can be fed to a fuel processor reactor.

The apparatus 100 can comprise further devices (not shown), and can be a component of a larger overall system, such as a fuel processor or a power plant comprising a fuel processor and a fuel cell. One such further device can be a program storage medium encoded with instructions that, when executed by a computer, perform a method comprising: receiving a report of a temperature of at least one point in a combustion zone of an oxidizer; and issuing a command to adjust an air flow rate to the combustion zone in response to the reported temperature.

In another embodiment, the present invention relates to a method of maintaining the temperature of at least one point within a combustion zone within a desired temperature range, comprising:

specifying the upper bound of the desired temperature range;

feeding air and a fuel to the combustion zone, wherein the air is fed at an air feed rate, the fuel is fed at a fuel feed rate, the amount of air and the amount of fuel present in the combustion zone define an oxygen to fuel ratio (“O/C ratio”), provided the O/C ratio is greater than the stoichiometric O/C ratio;

measuring the temperature of the at least one point within the combustion zone; and

increasing the air feed rate, if the temperature of the at least one point within the combustion zone is greater than about the upper bound of the desired temperature range, provided the O/C ratio remains greater than the stoichiometric O/C ratio.

The term “the temperature” is used in the preamble of this description of this embodiment in recognition that any given point will inherently have one and only one temperature. The combustion zone has been described above, and will inherently have a plurality of points. “At least one point” within the combustion zone refers to one point or a plurality of points within the combustion zone.

The “desired temperature range” refers to a range of temperature values which the temperature of the at least one point can desirably or tolerably be permitted to be within.

In one embodiment, the specifying step further comprises specifying the lower bound of the desired temperature range, and the method further comprises decreasing the air feed rate, if the temperature of the at least one point within the combustion zone is less than about the lower bound of the desired temperature range, provided the O/C ratio remains greater than the stoichiometric O/C ratio.

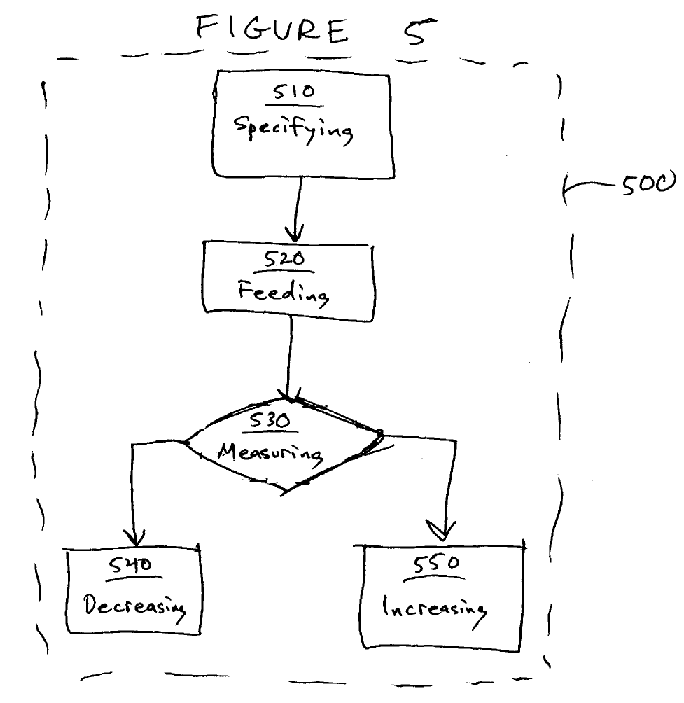

One embodiment of the method, comprising the decreasing step, is represented schematically in FIG. 5.

In the specifying step 510, the lower bound of the desired temperature range and the upper bound of the desired temperature range are specified. The particular value of the lower bound and the particular value of the upper bound can be routinely chosen by the operator of the method.

Generally, the upper bound is constrained by the physical limits imposed by the fuel combusted and the rate at which combustion occurs, which limit the energy released by combustion at any unit time, and the materials of which the combustion zone is fabricated, which limit the maximum temperature to which the combustion zone can be subjected without damage to the combustion zone. Also, though within the scope of the present invention, the skilled artisan would generally not be motivated to select an upper bound less than about ambient temperature. In selecting the upper bound, the operator will generally be aware of maximum safe or desirable temperatures for the zones or other locations to which heat from the combustion zone is to be transferred. For example, if the heat from the combustion zone is to be used to promote a chemical reaction in a reactor, and the chemical reaction is catalyzed by a catalyst which is deactivated at or above a particular temperature, the operator would generally be disposed to select an upper bound less than or about equal to the particular temperature.

In one embodiment, the upper bound is about 700° C. In another embodiment, the upper bound is about 750° C.

The lower bound can be selected to be any temperature value less than the upper bound. In one example, if the heat from the combustion zone is to be used to promote a chemical reaction in a reactor, and the rate of the chemical reaction is proportional to the temperature of the reactor, the operator would generally be disposed to select a high lower bound to accelerate the rate of the chemical reaction.

In one embodiment, the lower bound of the temperature range is about 500° C. In another embodiment, the lower bound of the temperature range is about 600° C.

In one embodiment, the lower bound of the temperature range is about 500° C. and the upper bound of the temperature range is about 750° C.

In the feeding step 520, air and a fuel are fed to the combustion zone. “Air,” as defined above, is any gas mixture comprising oxygen, and a “fuel” is any mixture comprising a hydrocarbon or hydrogen. A mixture comprising hydrogen may be referred to herein as a “reformate.” In one embodiment, the fuel comprises methane, natural gas, gasoline, diesel fuel, reformate, hydrogen, or a mixture of two or more thereof. The rate at which air is fed to the combustion zone can be referred to as an air feed rate, and the rate at which the fuel is fed to the combustion zone can be referred to as a fuel feed rate.

Together, the amount of air and the amount of fuel present in the combustion zone define an O/C ratio. The O/C ratio is calculated on a molar basis of oxygen (as diatomic molecular oxygen, O₂) to the combustible compound or compounds of the fuel. The combustible compound or compounds need not comprise carbon. For example, if 3 moles oxygen and 1 mole methane are present, the O/C ratio is 3. For another example, if 4 moles oxygen and 1 mole hydrogen are present, the O/C ratio is 4.

For any given fuel or mixture of fuels, there will be a value of the O/C ratio at which the combustion is stoichiometric, i.e., assuming total combustion, there is neither an excess of fuel nor an excess of oxygen. This value of the O/C ratio can be referred to as the “stoichiometric O/C ratio.” For example, when the fuel is methane (CH₄), the stoichiometric O/C ratio is 2, as given by the mass-balance equation CH₄+2O₂→CO₂+2H₂O. For a second example, when the fuel is benzene (C₆H₆), the stoichiometric O/C ratio is 7.5, as given by the mass-balance equation 2C₆H₆+15O₂→12CO₂+6H₂O. For a third example, when the fuel is molecular hydrogen (H₂), the stoichiometric O/C ratio is 0.5, as given by the mass-balance equation 2H₂+O₂→2H₂O. In general, the stoichiometric O/C ratio can be calculated as the number of molecules of oxygen divided by the number of molecules of the fuel considered as reactants in the appropriate mass-balance equation.

In the event that multiple fuels are present in the combustion zone and their proportions relative to each other are known, the stoichiometric O/C ratio can be calculated from the molar proportions of the various fuels. For example, if 0.75 moles of methane and 0.25 moles of hydrogen are present, the stoichiometric O/C ratio is (0.75*2)+(0.25*0.5)=1.625. If the proportions of the multiple fuels relative to each other are not known, but the different fuels and their total mass in the combustion zone are known, the stoichiometric O/C ratio of the entire fuel mixture can be estimated as being equal to the stoichiometric O/C ratio of the individual fuel with the highest stoichiometric O/C ratio.

In the method, the O/C ratio should be kept at greater than the stoichiometric O/C ratio. One of ordinary skill in the art will recognize that at O/C ratios lower than the stoichiometric O/C ratio the combustion will be incomplete, representing wasted fuel, combustion to CO instead of CO₂, or both. Either result is generally undesirable. The O/C ratio can be kept at greater than the stoichiometric O/C ratio by increasing the amount of air present in the combustion zone, decreasing the amount of fuel present in the combustion zone, or both.

In certain embodiments, it may be desirable to provide a minimum value of the O/C ratio greater than the stoichiometric O/C ratio. In one embodiment, this minimum value is about 5.

As the feeding step 520 proceeds, combustion of the fuel and air proceeds in the combustion zone. As combustion proceeds, heat is evolved, and such heat will tend to raise the temperature within the combustion zone or a portion thereof.

Continuing through FIG. 5, the measuring step 530 comprises measuring the temperature of the at least one point within the combustion zone. Measuring can be performed by any appropriate technique and device, such as a thermocouple, among others.

Upon performing the measuring step 530, the skilled artisan will understand that one of three results can be found. First, the temperature of the at least one point within the combustion zone can be within the desired temperature range. Second, the temperature of the at least one point within the combustion zone can be less than the lower bound of the desired temperature range. Third, the temperature of the at least one point within the combustion zone can be greater than the upper bound of the desired temperature range.

In the event that the first result obtains, namely, that the temperature of the at least one point within the combustion zone is within the desired temperature range, then no change in the O/C ratio is necessary. However, the O/C ratio can be adjusted within the desired temperature range in order to adjust the temperature of the at least one point within the combustion zone. Such adjustment may recommend itself to the skilled artisan if he or she desires to tune or optimize the heat evolved by the combustion, the temperature of a zone to be heated to which heat is transferred, or for other purposes he or she may find apparent. If performed, the adjustment can be performed according to the principles described below.

In the event that the second result obtains, namely, that the temperature of the at least one point within the combustion zone is less than the lower bound of the desired temperature range, then it is generally desirable to perform a decreasing step 540, wherein the O/C ratio is decreased, provided the O/C ratio remains greater than the stoichiometric O/C ratio. As the skilled artisan will understand, when the O/C ratio is greater than the stoichiometric O/C ratio, there will be excess oxygen which will not react with the fuel, but will instead be a diluent that will absorb heat evolved by the combustion. Given that temperature can be considered as being proportional to the average kinetic energy of molecules times the number of molecules, and the heat of the combustion reaction transferred to both product molecules (primarily CO₂ and H₂O) and diluent molecules (unreacted O₂, N₂, or other inert molecules that may be present if the “air” is not pure oxygen) will be the same regardless of the number of diluent molecules present, it follows that at lower O/C ratios, with fewer diluent molecules present, the same amount of heat evolved by the combustion will be imparted to a smaller number of molecules, resulting in a greater average kinetic energy of each molecule and a higher temperature. Therefore, decreasing the O/C ratio will generally increase the temperature of the at least one point within the combustion zone, and this will tend to return the temperature of the at least one point to a value greater than the lower bound of the desired temperature range.

The O/C ratio can be decreased by decreasing the air feed rate. This can be accomplished by any appropriate technique, such as slowing the speed of a blower forcing air into the system, lowering the draw of a pump pumping air into the system, among other techniques.

Alternatively, or in addition, the O/C ratio can be decreased by increasing the fuel feed rate. This can be accomplished by any appropriate technique. A combination of decreasing the air feed rate and increasing the fuel feed rate is also possible. However, in many embodiments, it may be more convenient, more economical, or both to decrease the O/C ratio solely by decreasing the air feed rate. Air is generally less expensive than is an increase in consumed fuel. Also, if fuel is used in other related apparatus or methods, such as reforming in a reformer as part of a fuel cell, the same fuel stock may be drawn from to feed both the combustion zone and the reformer, and thus a fuel feed that is complex relative to the air feed may be required.

In the event that the third result obtains, namely, that the temperature of the at least one point within the combustion zone is greater than the upper bound of the desired temperature range, then it is generally desirable to perform an increasing step 550, wherein the O/C ratio is increased, provided the O/C ratio remains greater than the stoichiometric O/C ratio. As discussed above, when the O/C ratio is greater than the stoichiometric O/C ratio, there will be excess oxygen which will not react with the fuel, but will instead be a diluent that will absorb heat evolved by the combustion. Given the above discussion of temperature and heat, it follows that at higher O/C ratios, with more diluent molecules present, the same amount of heat evolved by the combustion will be imparted to a larger number of molecules, resulting in a lower average kinetic energy of each molecule and a lower temperature. Therefore, increasing the O/C ratio will generally decrease the temperature of the at least one point within the combustion zone, and this will tend to return the temperature of the at least one point to a value less than the upper bound of the desired temperature range.

The O/C ratio can be increased by increasing the air feed rate. This can be accomplished by any appropriate technique, such as raising the speed of a blower forcing air into the system, increasing the draw of a pump pumping air into the system, among other techniques.

Alternatively, or in addition, the O/C ratio can be increased by decreasing the fuel feed rate. This can be accomplished by any appropriate technique. A combination of increasing the air feed rate and decreasing the fuel feed rate is also possible. However, in many embodiments, it may be more convenient, more economical, or both to increase the O/C ratio solely by increasing the air feed rate. If fuel is used in other related apparatus or methods, such as reforming in a reformer as part of a fuel cell, the same fuel stock may be drawn from to feed both the combustion zone and the reformer, and thus a fuel feed that is complex relative to the air feed may be required.

Regardless of whether the measuring step 530 indicates that at any particular moment the O/C ratio need not be changed, be lowered in a decreasing step 540, or be increased in an increasing step 550, the skilled artisan will understand that steps 530-550 can be repeated indefinitely at any desired rate of repeating, i.e., the measuring step 530 can be performed at a desired periodicity and the decreasing step 540 or the increasing step 550, or both, can be performed at the same or a different periodicity.

The method has been described in two embodiments as having either an increasing step or an increasing step and a decreasing step. In another embodiment, the method has a decreasing step. In other words, in this embodiment, the method comprises:

specifying the lower bound of the desired temperature range;

feeding air and a fuel to the combustion zone, wherein the air is fed at an air feed rate, the fuel is fed at a fuel feed rate, the amount of air and the amount of fuel present in the combustion zone define an O/C ratio, provided the O/C ratio is greater than the stoichiometric O/C ratio;

measuring the temperature of the at least one point within the combustion zone; and

decreasing the air feed rate, if the temperature of the at least one point within the combustion zone is less than about the lower bound of the desired temperature range, provided the O/C ratio remains greater than the stoichiometric O/C ratio.

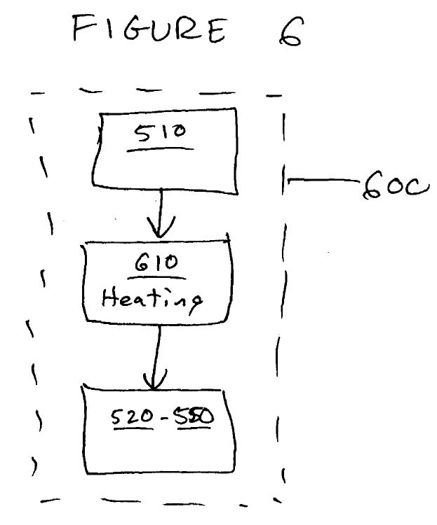

In addition to the steps described above, the method can comprise additional steps. In one embodiment, represented in FIG. 6, the method 600 further comprises, after the specifying step, a heating step 610, comprising heating the at least one point within the combustion zone to a first temperature less than the upper bound of the desired temperature range. Such a heating step can be useful in providing sufficient heat to activate the combustion of the fuel and air, analogous to the lighting of a pilot light in a propane or natural gas stove, oven, furnace, water heater, or similar appliance. The heating step 610 generally need only be performed until the combustion reaction has begun, as the heat evolved by combustion will generally be sufficient to activate the combustion of fresh or recycled air and fresh or recycled fuel fed thereafter to the combustion zone. However, if it is desired to continue the heating step 610 beyond that point in time, such continued heating is within the scope of the present invention.

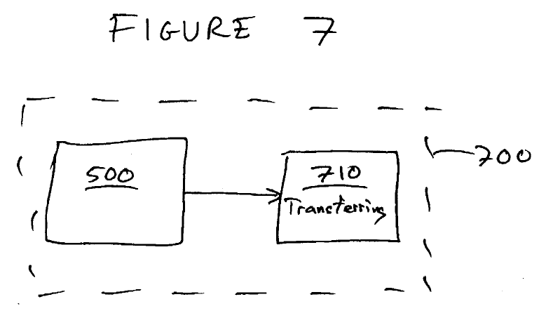

In another embodiment, represented in FIG. 7, the method 700 further comprises a transferring step 710, comprising transferring heat from the combustion zone to a zone to be heated. The transferring step 710 can make use of any appropriate apparatus or technique for transferring heat to any appropriate zone to be heated. The transfer of heat can make use of one or more of conduction, convection, or radiation. In one embodiment, the transfer of heat can be performed by use of a coiled line, such as a coiled stainless steel line, which is in fluid communication with the zone to be heated.

In one embodiment, the zone to be heated comprises a reformer, an oxidizer, or both, as have been described above.

The reformer can be an autothermal reformer, that is, a reformer capable of performing an autothermal reforming step in which two reactions, a partial oxidation (formula I, below) and an optional steam reforming (formula II, below), are combined to convert a fuel feed stream into a synthesis gas containing hydrogen and carbon monoxide. Formulas I and II are exemplary reaction formulas wherein methane is considered as the hydrocarbon:

CH₄+½O₂→2H₂+CO (I)

CH₄+H₂O→3H₂+CO (II)

The operating temperature in the autothermal reformer can range from about 500° C. to about 900° C., depending on the feed conditions and the catalyst. In one embodiment, wherein the catalyst is sensitive to temperatures above about 750° C., the operating temperature in the autothermal reformer is from about 500° C. to about 750° C.

Additional processes that can be performed by a reformer include:

cooling the effluent of the autothermal reforming step,

removing hydrogen sulfide from the effluent (such as by use of zinc oxide as a hydrogen sulfide absorbent, as in reaction formula III:

H₂S+ZnO→H₂O+ZnS (III)),

water gas shift reacting to convert carbon monoxide to carbon dioxide, preferably to an extent wherein the concentration of carbon monoxide is lowered to a level that can be tolerated by fuel cells, typically below 50 ppm, in accordance with formula IV:

H₂O+CO→H₂+CO₂ (IV),

an additional cooling step,

oxidizing, wherein almost all of the remaining carbon monoxide in the effluent stream is converted to carbon dioxide, typically in the presence of a catalyst for the oxidation of carbon monoxide, involving typically both the desired oxidation of carbon monoxide (formula V) and the undesired oxidation of hydrogen (formula VI) as follows, considering, for example, that the preferential oxidation of carbon monoxide is favored by low temperatures:

CO+½O₂→CO₂ (V)

H₂+½O₂→H₂O (VI),

thus forming a reformate, in this particular embodiment a hydrogen rich gas containing carbon dioxide and other constituents which may be present such as water, inert components (e.g., nitrogen, argon), residual hydrocarbon, etc. Product gas may be used as the feed for a fuel cell or for other applications where a hydrogen rich feed stream is desired. Optionally, product gas may be sent on to further processing, for example, to remove the carbon dioxide, water or other components.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An apparatus, comprising:
an air feed;
a fuel feed;
a combustion zone, capable of mixing and combusting air and fuel therein;
a temperature sensor positioned within the combustion zone, capable of measuring the temperature of at least one point within the combustion zone; and a control system, comprising:
a processor to which the temperature sensor is capable of reporting the measured temperature; and
an air flow adjustment apparatus controlled by the processor and capable of adjusting the flow rate of air to the combustion zone in response to the reported temperature.

2. The apparatus of claim 1, further comprising a heater within the combustion zone.

3. The apparatus of claim 1, further comprising a zone to be heated and a heat transfer apparatus capable of transferring heat between the combustion zone and the zone to be heated.

4. The apparatus of claim 3, wherein the zone to be heated comprises a reformer, an oxidizer, or both.

5. A method of maintaining the temperature of at least one point within a combustion zone within a desired temperature range, comprising:
specifying the upper bound of the desired temperature range;
feeding air and a fuel to the combustion zone, wherein the air is fed at an air feed rate, the fuel is fed at a fuel feed rate, the amount of air and the amount of fuel present in the combustion zone define an oxygen to fuel ratio (“O/C ratio”), provided the O/C ratio is greater than the stoichiometric O/C ratio;
measuring the temperature of the at least one point within the combustion zone; and
increasing the air feed rate, if the temperature of the at least one point within the combustion zone is greater than about the upper bound of the desired temperature range, provided the O/C ratio remains greater than the stoichiometric O/C ratio.

6. The method of claim 5, wherein the upper bound of the temperature range is about 750° C.

7. The method of claim 5, wherein the specifying step further comprises specifying the lower bound of the desired temperature range, and wherein the method further comprises decreasing the air feed rate, if the temperature of the at least one point within the combustion zone is less than about the lower bound of the desired temperature range, provided the O/C ratio remains greater than the stoichiometric O/C ratio.

8. The method of claim 7, wherein the lower bound of the temperature range is about 500° C. and the upper bound of the temperature range is about 750° C.

9. The method of claim 5, further comprising heating the at least one point within the combustion zone to a first temperature less than the upper bound of the desired temperature range.

10. The method of claim 5, wherein the fuel comprises methane, natural gas, gasoline, diesel fuel, reformate, hydrogen, or a mixture of two or more thereof.

11. The method of claim 5, wherein the O/C ratio is and remains greater than about 5.

12. The method of claim 5, further comprising:
transferring heat from the combustion zone to a zone to be heated.

13. The method of claim 12, wherein the zone to be heated comprises a reformer, an oxidizer, or both.

14. A method of maintaining the temperature of at least one point within a combustion zone within a desired temperature range, comprising:
specifying the lower bound of the desired temperature range;
feeding air and a fuel to the combustion zone, wherein the air is fed at an air feed rate, the fuel is fed at a fuel feed rate, the amount of air and the amount of fuel present in the combustion zone define an O/C ratio, provided the O/C ratio is greater than the stoichiometric O/C ratio;
measuring the temperature of the at least one point within the combustion zone; and
decreasing the air feed rate, if the temperature of the at least one point within the combustion zone is less than about the lower bound of the desired temperature range, provided the O/C ratio remains greater than the stoichiometric O/C ratio.

15. A method for use in reforming a fuel, comprising:
feeding air to a combustion zone;
feeding a fuel to a combustion zone;
measuring the temperature of at least one point within the combustion zone; and
adjusting the flow rate of the air to the combustion zone in response to the reported temperature.

16. A fuel processor, comprising:
an air feed;
a fuel feed;
an oxidizer, comprising:
a combustion zone, capable of mixing and combusting air and fuel therein;
a temperature sensor positioned within the combustion zone, capable of measuring the temperature of at least one point within the combustion zone; and
a control system, including:
a processor to which the temperature sensor is capable of reporting the measured temperature; and
an air flow adjustment apparatus controlled by the processor and capable of adjusting the flow rate of air to the combustion zone in response to the reported temperature.

17. A power plant, comprising:
a fuel cell;
a fuel processor, including:
an air feed;
a fuel feed;
an oxidizer, containing:
a combustion zone, capable of mixing and combusting air and fuel therein;
a temperature sensor positioned within the combustion zone, capable of measuring the temperature of at least one point within the combustion zone; and
a control system, comprising:
a processor to which the temperature sensor is capable of reporting the measured temperature; and
an air flow adjustment apparatus controlled by the processor and capable of adjusting the flow rate of air to the combustion zone in response to the reported temperature.

18. The power plant of claim 17, wherein the oxidizer oxidizes tailgas from an anode of the fuel cell.

19. A control system for an oxidizer in a fuel processor, comprising:
a processor capable of receiving a temperature of at least one point in a combustion zone of the oxidizer; and
an air flow adjustment apparatus controlled by the processor and capable of adjusting the flow rate of air to the combustion zone in response to the reported temperature.

20. A program storage medium encoded with instructions that, when executed by a computer, perform a method comprising:
receiving a report of a temperature of at least one point in a combustion zone of an oxidizer; and
issuing a command to adjust an air flow rate to the combustion zone in response to the reported temperature.
